(19) United States
(12) Patent Application Publication
(10) Pub. No.: US 2013/0094896 A1
(43) Pub. Date: Apr. 18, 2013

(54) CONNECTING ELEMENT FOR A FRICTION-WELDED CONNECTION FOR CONNECTING AT LEAST TWO PANEL-LIKE COMPONENTS

(71) Applicants: Eberhard Christ, Tambach-Dietharz (DE); Joerg Thiem, Zella-Mehlis (DE); Mario Maiwald, Creuzburg (DE); Gerhard Dubiel, Tambach-Dietharz (DE); Sebastian Zebisch, Tambach-Dietharz (DE); Nico Oschmann, Friedrichroda (DE); Marco Werkmeister, Leinatal (DE)

(72) Inventors: Eberhard Christ, Tambach-Dietharz (DE); Joerg Thiem, Zella-Mehlis (DE); Mario Maiwald, Creuzburg (DE); Gerhard Dubiel, Tambach-Dietharz (DE); Sebastian Zebisch, Tambach-Dietharz (DE); Nico Oschmann, Friedrichroda (DE); Marco Werkmeister, Leinatal (DE)

(73) Assignee: EJOT GMBH & CO. KG, Bad Berleburg (DE)

(21) Appl. No.: 13/806,408

(22) PCT Filed: Jun. 21, 2011
(86) PCT No.: PCT/EP11/60311

§ 371 Date: Dec. 21, 2012

(30) Foreign Application Priority Data
Jun. 23, 2010 (DE) 10 2010 017 550.1

(51) Int. Cl. F16B 5/08

(52) U.S. Cl. CPC F16B 5/08
USPC 403/267

(57) ABSTRACT

The invention relates to a connecting element (1) for a friction-welded connection for connecting at least two panel-like components (8,9), comprising a rotating and pressurised mandrel (2, 13), the length of which is adapted to the thickness of the upper component(s) (7, 8) in order to penetrate the upper components(s) (7, 8), and which has a polygonal noncircular profile having rounded corner regions (5a, 5b). The noncircular profile has a thread-like design and has a pitch, the length of which is shorter than a complete thread turn.

The invention relates to a connecting element for a friction-welded connection for connecting at least two panel-like components. Said connecting element comprises a rotating and pressurised mandrel, the length of which is adapted to the thickness of the upper component(s) in order for the mandrel to penetrate the upper component(s), and which has a polygonal noncircular profile having rounded corner regions.

A connecting element of this type is shown in FIGS. 5A and 5B of DE 10 2009 006 775A1. As is explained in the associated descriptive text, the noncircular profile creates free spaces for the removal of chips and abraded particles.

Furthermore, an anchoring projectile to be driven into metals is known from British patent specification 7 32 203. This projectile has a mandrel which is to be driven into some metal and exhibits relatively short and slightly inclined ribs that are closely located adjacent to each other and are to ensure that the projectile is anchored in the metal in a particularly secure manner.

The present invention is a connecting element for a friction-welded connection for connecting at least two panel-like components. It is the object of this invention to specifically create a space for the material removed in the friction-welding process—for which purpose the force applied is also used—through which such material can then be discharged. According to the invention, this is accomplished in that the noncircular profile is of a thread-like design and in that the corner regions extending along said mandrel (2) exhibit a pitch which is shorter in length than an entire thread turn.

Owing to the thread-like design of the noncircular profile, the cavities located between the corner regions extend in such a way that their thread-like design specifically guides the removed material away from the friction-welding site. At the same time, the threaded guide of the cavities during rotation of the connecting element results in the removed material being kind of sucked away from the melting site. This prevents accumulation of and/or congestion due to, too much molten material and ensures that the connection between the connecting element and the lower panel is accomplished in a particularly reliable manner.

The pitch of the noncircular profile may either be designed as a right-hand thread or as a left-hand thread. This depends on the direction in which the connecting meeting element is rotated during friction welding. Preferably, the direction of the pitch is chosen in accordance with the direction of rotation during friction welding.

The drawings illustrate embodiments of the invention. In detail,

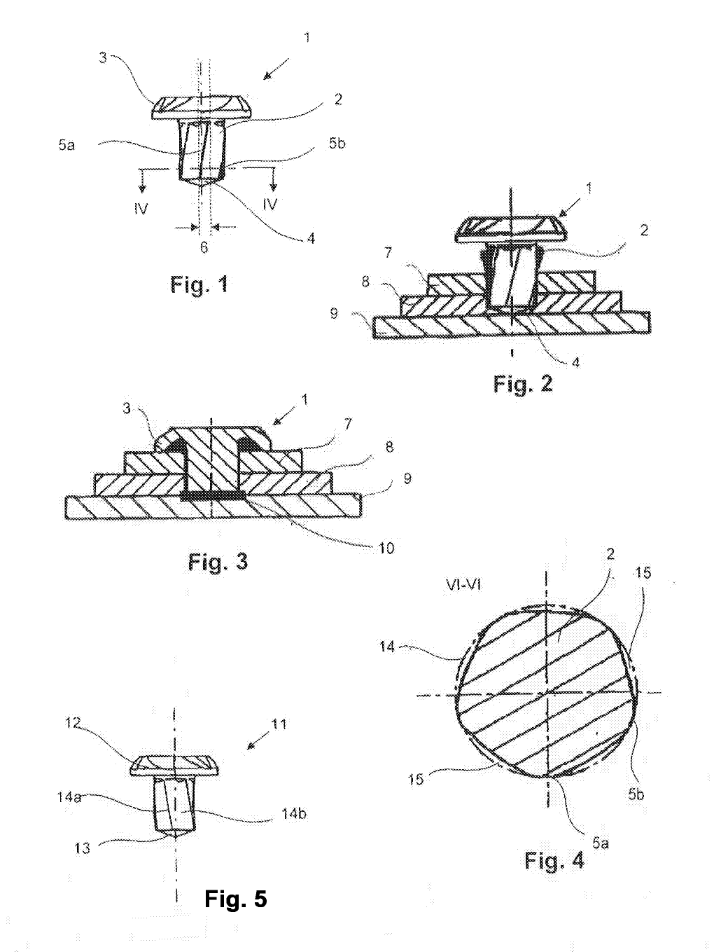

FIG. 1 is a view of a connecting element having a head consisting of a collar and associated mandrel for obtaining a friction-welded connection, said mandrel having rounded corner regions indicated by lines;

FIG. 2 is a view of the connecting element of FIG. 1 with two panel-like upper components and one panel-like lower component, in which the connecting element has already penetrated the two upper components by means of a melting process;

FIG. 3 is a view of the same connecting element in which the mandrel has already completely penetrated the two upper panels and has partially penetrated and established a friction-welded correction with the lower panel;

FIG. 4 a cross-sectional view along lines IV-IV of FIG. 1 which, on the one hand, shows the material of the mandrel in cross-section, and—opposite an imaginary circumferential line—recessed cavities between rounded corner regions; and

FIG. 5 essentially the same view as that of FIG. 1 but in which the pitch of the corner regions extends in the opposite direction.

FIG. 1 shows the connecting element 1 which consists of the mandrel 2 and its associated collar 3. On its side facing away from the collar 3, the mandrel 2 terminates in a truncated cone 4 which has a certain centering effect during the friction-welding process. However, it is also possible to provide the mandrel 2 with a planar end surface. The two drawn lines 5a and 5b that extend obliquely along the mandrel 2 indicate rounded corner regions which define free spaces between them whose effect and design will be discussed in more detail with reference to FIG. 4. The corner regions 5a and 5b extend obliquely with respect to the longitudinal axis of the connecting element 1, which is to indicate their design in the form of a thread which in this case extends with a small amount of offset. More precisely, the offset of the corner regions 5a and 5b along the length of the mandrel 2 is shorter than a complete thread turn. Thus the thread 5a and 5b are of a pitch each that is shorter than a complete thread turn would be.

The view of FIG. 1 schematically shows the offset of the corner regions, i.e. through the dot-dash lines extending from the ends of the corner regions 5a and 5b to the distance 6 which directly indicates the actual offset.

Shown in FIG. 2 is the connecting element 1 together with the two upper panels 7, 8 and a base panel 9. In this case, the panels 7 and 8 may be aluminium plates for example, whereas the base panel 9 is a steel plate. In this view, the mandrel 2 of the connecting element 1 has completely penetrated the two panels 7 and 8 by means of pressure and rotation, causing the material of the panels to melt. FIG. 2 shows the mandrel 2 in a position in which its truncated cone 4 abuts the base panel 9 and causes the material of the cone to melt under the influences of rotation and pressure at this point. Depending on the material chosen for the panel 9, this will also melt to some extent, thus resulting in a friction-welded connection.

FIG. 3 shows the process illustrated in FIG. 2 in its final stage, in which the connecting element 1 has completed its friction-welded connection 10 to the base panel 9 in a known manner. Consequently, the three panels 7, 8, 9 are now firmly connected to each other, i.e. from the base panel 9 all along the connecting element 1 and up to its collar 3. In other words, a solid connection of all these components has been accomplished. It should be noted that it is also possible to use a single panel only instead of the two upper panels 7 and 8, depending on the final configuration intended for the connected components.

FIG. 4 is a cross-sectional view taken along lines IV-IV of FIG. 1 and illustrates the shape of the mandrel 2. In order to illustrate the embodiment of the noncircular profile more clearly, a dotted circular line 14 has been drawn into FIG. 4. Contained within this circular line 14 is the cross-section along lines IV-IV of FIG. 1 which represents the external shape of the mandrel 2. As is shown in FIG. 4, the mandrel 4 has five rounded corner regions, two of which are marked 5a and 5b. Between these corner regions, the noncircular embodiment of FIG. 4 has the cavities 15 which are obtained when the mandrel 2 has penetrated the material of the panels 7 and 8 shown in FIG. 2. These cavities 15 can be used to discharge material removed from the panels 7 and 8 and from the friction-welding site 10.

FIG. 5 is a schematic view of a connecting element similar to the connecting element 11 of FIG. 1, which consists of a collar 12 and a mandrel 13 that has the schematically shown corner regions 14a and 14b on its outer surface. As is clearly shown in FIG. 5, the corner regions 14a and 14b extend with a pitch which is opposite to the pitch of the corner regions 5a and 5b of FIG. 1. The respective direction of the pitch is chosen based on the direction of rotation of the respective connecting element in the friction-welding process, i.e. in such a way that the direction of pitch is aligned with the direction of rotation of the respective mandrel 2 or 13 as in the case of a spiral drill. This means that, for a connecting element according to FIG. 1, its direction of rotation would be comparable to a right-hand twist whereas, when a connecting element 11 of the type shown in FIG. 5 is used, the direction of rotation for the friction-welding process would be of the opposite type, i.e. comparable to a left-hand twist.

### LIST OF REFERENCE SIGNS

1 connecting element

2 mandrel

3 associated collar

4 truncated cone

5 rounded cornet regions 5a and 5b

6 distance

7 upper panel

8 upper panel

9 base panel

10 friction-welded connection

11 connecting element

12 collar

13 mandrel

14 rounded corner regions 14a and 14b

15 cavity

1-3. (canceled)

4. A connecting element (1) for a friction-welded connection for connecting at least two panel-like components (8, 9) comprising a rotating and pressurised mandrel (2, 13), the length of which is adapted to the thickness of the upper component(s) (7, 8) in order for the mandrel to penetrate the upper component(s) (7, 8), and which has a polygonal noncircular profile having rounded corner regions (5a, 5b) characterized in that the noncircular profile has a thread-like design such that the corner regions extending along the mandrel (2) have some amount of offset, said offset of said corner regions (5a, 5b) along the length of the mandrel (2) being shorter than a complete thread turn.

5. The connecting element of claim 4 characterized in that the pitch extends in the manner of a right-hand thread.

6. The connecting element of claim 4 characterized in that the pitch extends in the manner of a left-hand thread.
